(19) United States
(12) Patent Application Publication
(10) Pub. No.: US 2019/0126843 A1
(43) Pub. Date: May 2, 2019

(54) HANDHELD UNIT CONTROL DEVICE FOR VEHICLES

(71) Applicant: NEKA SOLUTION INC., Berthier-sur-Mer (CA)

(72) Inventors: Michel Bouchard, Berthier-sur-Mer (CA); Christian Gauvin, Levis (CA); Jean-Philippe Gagnon, Montreal (CA); Gilles Chouinard, Ste-Marie (CA); Franc Hauselmann, Quebec (CA); Martin Bissonnette, Montreal (CA); James Anglehart, Montreal (CA)

(21) Appl. No.: 16/210,313

(22) Filed: Dec. 5, 2018

Related U.S. Application Data
(63) Continuation-in-part of application No. PCT/CA2017/050825, filed on Jul. 17, 2017.
(60) Provisional application No. 62/618,360, filed on Jan. 17, 2018.
(60) Provisional application No. 62/360,403, filed on Jul. 10, 2016.

(51) Int. Cl. B60R 11/02; B60R 16/03; G01S 19/13

(52) U.S. Cl. CPC B60R 11/02; B60R 11/0241; B60R 2011/0071; B60R 16/03; G01S 19/13; B60R 11/0252

(57) ABSTRACT

A holder for securing a phone, smartphone or tablet device while driving in a vehicle. The holder has a frame for supporting the device including a base or socket shaped to receive at least a portion of the device, and a clamping mechanism configured to secure the device in the socket; a locking mechanism connected to the clamping mechanism, the locking mechanism comprising a motor actuating a driving member to engage and disengage a driven member of the clamping mechanism to cause the clamping mechanism to lock while tightening its grip on the device and to unlock while loosening its grip on the device.

The present application is a continuation-in-part of PCT/CA2017/050825 filed on Jul. 7, 2017 that claims priority from U.S. provisional patent application No. 62/360,403 filed on Jul. 10, 2016, which is incorporated herein by reference. The present application also claims priority from U.S. provisional patent application No. 62/618,360 filed on Jan. 17, 2018 incorporated herein by reference.

### TECHNICAL FIELD

This patent application relates to the field of devices used to control the use of handheld units by drivers of vehicles.

### BACKGROUND

In recent years, motor vehicle accident rates in which the use of handheld wireless telephones and computing devices have been demonstrated to be higher than for other conditions. According to information released by the Canadian Automobile Association, drivers engaged in text messaging on a cellular phone are 23 times more likely to be involved in a crash or near crash event compared with non-distracted drivers. In the United States, it is reported that 1 out of every 4 car accidents is caused by texting and driving, and that texting while driving is six times more likely to cause an accident than driving drunk.

A variety of solutions have been proposed to help drivers avoid the distraction of a mobile telephone/smartphone device. Some solutions involve restricting access to the mobile device while driving, and others involve disabling the mobile device while driving. The general object is to reduce or eliminate the distraction of the mobile device while driving.

Most solutions require professional installation of equipment into the vehicle and are complex in nature.

In U.S. Pat. No. 8,884,750, there is disclosed a holder for a mobile device that provides an alert when the mobile device is removed from the holder. In one example, the holder can include a mounting to a cigarette lighter socket, and does not require professional installation.

### SUMMARY

Applicant has found that vehicle drivers need a simple and easy to use tool to help them respect their intentions to avoid hand held use of handheld wireless telephones and computing devices while driving. Most any system can be defeated, while most drivers have good intentions to comply with non-use of such devices when getting into their vehicles.

In accordance with some embodiments, a handheld device storage unit for use in a vehicle has a locking mechanism connected to auxiliary power of the vehicle that allows a driver to lock the handheld device when the vehicle is on and to unlock the device when the vehicle is off. In this way, the driver can use the locking mechanism to secure the handheld device while driving so that the ability to make handheld use of the handheld device is made difficult or impossible.

The locking mechanism can be a holder that holds the handheld device for the driver to use in a hands-free mode. The locking mechanism can be a small lock box into which the handheld device to secured while driving.

In the case that the locking mechanism is a holder that holds the handheld device for the driver to use in a hands-free mode, the holder can have a clamping mechanism for holding the handheld device. In some examples, the device can only be released when auxiliary power is off, namely when the vehicle is off.

To simplify installation, the connection to auxiliary power can be taken from a vehicle interior connector, such as but not limited to, a cigarette lighter 12V DC receptacle or a USB connector. This avoids needing to connect the device to vehicle auxiliary power behind the vehicle dashboard.

When power is taken from a vehicle interior connector, the handheld device storage unit can comprise a mechanism to reduce the temptation to defeat the device while driving. One mechanism is to use a connector that can detect its removal from its socket. The socket can be, for example, a 12V DC socket or a USB socket, and the connector can have a switch that is actuated by the initial removal of the connector preferably before power is disconnected. Another mechanism is to use a locking connector, such as a connector with screws securing the connector in place, for example a lockable USB connector. A 12V DC cigarette lighter connector can be fitted with a mechanical lock to lock it into its receptacle, while providing power to the handheld device storage unit using a fixed cable or via an additional power socket, such as a lockable connector or for use with a connector that can detect its removal.

A first broad aspect is directed to a holder for securing a phone, smartphone or tablet device while driving in a vehicle. The holder has a frame for supporting the device with a socket shaped to receive at least a portion of the device and a clamping mechanism configured to secure the device in the socket. The holder has a lock connected to the clamping mechanism, and a cable connectable to the vehicle to receive a signal from the vehicle indicative of a state of the vehicle. The lock is responsive to the signal and is configured, when the vehicle is in a first state, to lock the clamping mechanism so that the device is secured and cannot be removed from the holder, and when the vehicle is in a second state, to unlock the clamping mechanism so that the device is free to be removed from the holder.

In some embodiments, the holder may have a proximity sensor that is configured to detect the device when placed in the frame. In some embodiments, the holder may have a visual indicator configured to receive information from the proximity sensor as to the detection of the device in the frame, and further configured to receive a signal when the vehicle is turned on, the visual indicator providing a visual indication when the vehicle is turned on and the proximity sensor does not detect the presence of the device. The visual indicator may further be configured to produce an audible alarm in addition to the visual indication when the vehicle is turned on and the proximity sensor does not detect the presence of the device.

In some embodiments, the holder may have computer-readable memory, and a controller that can access the memory and that may be configured to receive information from the proximity sensor regarding the detection of the device, and/or from the vehicle regarding the state of the vehicle transmitted via the cable. The controller may be further configured to store the information in the memory. The controller may be further configured to associate said log information with temporal information corresponding to the time of the event corresponding to said log information and wherein said temporal information is obtained by, in the embodiments where the holder has a clock, the clock of the holder, a clock of the vehicle or a clock of the device.

In some embodiments, the holder may have a data output interface, and wherein the information is accessible via the data output interface. the data output interface may be a wireless data output interface. The data output interface may be a wired data output interface.

In some embodiments, the first state may be when the vehicle is turned on and the second state may be when the vehicle is turned off. In some embodiments, the first state may be when the vehicle is detected as travelling over a designated speed, and the second state may be when the vehicle is detected as travelling at or under the designated speed. The designated speed may be 0 miles per hour. The first state may be when the vehicle is detected as going over a designated revolutions per minute, and the second state may be when the vehicle is detected as going at or under the designated revolutions per minute.

In some embodiments, the holder may have a mounting to be connected to the vehicle.

The cable may end in a plug connectable to a vehicle power socket for receiving power when a vehicle is turned on. The vehicle power socket may be a car computer port of the vehicle. The car computer port may be an on-board diagnostics port. The plug may be a cigarette lighter plug. The vehicle power socket may have a cigarette lighter socket. The plug may have a USB socket.

In some embodiments, the plug may have a connection sensor and the clamping mechanism may have a control circuit and power storage, and the control circuit may be responsive to the sensor to prevent the lock from unlocking the clamping mechanism when power is not present in the cable and when the connection sensor senses disconnection of the plug. The plug may have a locking mechanism to prevent easy removal of the plug from the vehicle power socket.

The plug may provide a further plug for a further socket, and the cable may be solidly connected to the plug. The cable may be solidly connected to the frame. The frame may have a charging port for charging the device using power from the cable. The holder may be connectable to the vehicle to obtain information regarding the speed of the vehicle.

In some embodiments, the holder may have a radio-frequency identification mechanism for identifying the device.

A second broad aspect is a holder for securing a phone, smartphone or tablet device while driving in a vehicle. The has a frame for supporting or containing the device, a cable terminating in a plug connectable to a vehicle power socket for receiving power when a vehicle is turned on, a lock for securing the device in the holder, and an actuator controlled by power from the cable for preventing the lock from releasing the device when power is present in the cable.

In some embodiments, the lock has at least one clamp and at least one support for locking the device from sides thereof, where the holder may have a mounting for connecting to a vehicle. The plug may have a connection sensor and the lock may have a control circuit and power storage, and the control circuit may be responsive to the sensor to cause the actuator to prevent the lock from releasing the device when power is not present in the cable and when the connection sensor senses disconnection of the plug. The plug may have a locking mechanism to prevent easy removal of the plug from the vehicle power socket. The plug may be a cigarette lighter plug. The plug may have a cigarette lighter socket. The plug may have a USB socket. The plug may provide a socket for a further plug, and the cable is solidly connected to the plug.

The cable may be solidly connected to the frame. The frame may have a charging port for charging the device using power from the cable.

A third broad aspect is a method of securing a phone, smartphone or tablet device while driving in a vehicle. the method involves connecting a cable to a vehicle power socket for receiving power when a vehicle is on and not receiving power when the vehicle is off. The method also involves placing the device in a frame with a socket that is shaped to receive at least part of the device, the frame having a clamping mechanism for securing the device in the socket, the clamping mechanism connected to a lock. The method also includes putting the vehicle in a first state, the entering the first state resulting in the lock locking the clamping mechanism, wherein the device is secured in the frame and cannot be removed from the frame when the clamping mechanism is locked. The method also involves putting the vehicle in a second state, the entering the second state causing the lock to unlock the locked clamping mechanism, wherein the device is removable from the frame when the clamping mechanism is unlocked. The method involves removing the device from the frame.

In some embodiments, the method may involve mounting the frame for supporting the device on or near a vehicle dash so that a screen of the device is visible to a driver. In some embodiments, the connecting a cable may include locking the plug in the vehicle power socket using a lock mechanism.

In some embodiments, the first state may be entered when the vehicle is turned on and wherein the second state may be entered when the vehicle is turned off. The first state may be entered when the vehicle is detected as travelling above a designated speed and wherein the second state may be entered when the vehicle is detected as travelling at or under the designated speed. The first state may be entered when the vehicle is detected as going over a designated revolutions per minute, and the second state may be entered when the vehicle is detected as going at or under the designated revolutions per minute.

In some embodiments, the method may involve detecting the presence of the device in the frame. The method may involve creating log information including the time at which the vehicle has entered the first state and when the vehicle has entered the second state. The created log information may include the time at which the presence of the device is detected in the frame. In some embodiments, the method may involve retrieving from the memory the log information and accessing the log information via one of a remote computer and the device. The accessing may involve transmitting the log information via a transmission device on-board the vehicle.

A fourth broad aspect is a method of securing a phone, smartphone or tablet device while driving in a vehicle. The method involves connecting a cable terminating in a plug connectable to a vehicle power socket for receiving power when a vehicle is turned on and not receiving power when the vehicle is off. The method involves placing the device in a frame adapted for supporting or containing the device, the frame having a lock for securing the device in the holder, the lock being controlled by an actuator controlled by power from the cable for preventing the lock from releasing the device when power is present in the cable. The method involves locking the device in the holder such that the device cannot be hand held while the vehicle is turned on. The method involves turning the vehicle off so as to permit the actuator to allow the device to be removed from the frame for supporting or containing the device in the holder. The method involves removing the device from the holder.

In some embodiments, the method involves mounting the frame for supporting the device on or near a vehicle dash so that a screen of the device is visible to a driver. The connecting a cable may include locking the plug in the vehicle power socket using a lock mechanism.

Another broad aspect is holder for securing a phone, smartphone or tablet device while driving in a vehicle. The holder includes a frame for supporting the device including a socket shaped to receive at least a portion of the device; and a clamping mechanism configured to secure the device in the socket; a lock connected to the clamping mechanism; and a cable connectable to the vehicle to receive a signal from the vehicle indicative of a state of the vehicle; wherein the lock is responsive to the signal and is configured, when the vehicle is in a first state, to lock the clamping mechanism so that the device is secured and cannot be removed from the holder, and when the vehicle is in a second state, to unlock the clamping mechanism so that the device is free to be removed from the holder.

In some embodiments, the holder may include a proximity sensor that is configured to detect the device when placed in the frame.

In some embodiments, the holder may include a visual indicator configured to receive information from the proximity sensor as to the detection of the device in the frame, and may be further configured to receive a signal when the vehicle is turned on, the visual indicator providing a visual indication when the vehicle is turned on and the proximity sensor does not detect the presence of the device.

In some embodiments, the visual indicator may be further configured to produce an audible alarm in addition to the visual indication when the vehicle is turned on and the proximity sensor does not detect the presence of the device.

In some embodiments, the holder may include computer-readable memory; and a controller that can access the memory and that is configured to receive log information from the proximity sensor regarding the detection of the device; and/or the vehicle regarding the state of the vehicle transmitted via the cable.

In some embodiments, the controller may be further configured to associate the log information with temporal information corresponding to the time of the event corresponding to the log information and wherein the temporal information is obtained by, wherein the holder further comprises a clock, the clock of the holder; a clock of the vehicle; or a clock of the device.

In some embodiments, the holder may include a data output interface, and wherein the log information may be accessible via the data output interface.

In some embodiments, the data output interface may be a wireless data output interface.

In some embodiments, the data output interface may be a wired data output interface.

In some embodiments, the first state may be when the vehicle is turned on and the second state is when the vehicle is turned off.

In some embodiments, the first state may be when the vehicle is detected as travelling over a designated speed, and the second state may be when the vehicle is detected as travelling at or under the designated speed.

In some embodiments, the designated speed may be 0 miles per hour.

In some embodiments, the first state may be when the vehicle is detected as going over a designated revolutions per minute, and the second state may be when the vehicle is detected as going at or under the designated revolutions per minute.

In some embodiments, the holder may include a mounting to be connected to the vehicle.

In some embodiments, the cable may end in a plug connectable to a vehicle power socket for receiving power when a vehicle is turned on.

In some embodiments, the vehicle power socket may be a car computer port of the vehicle.

In some embodiments, the car computer port may be an on-board diagnostics port.

In some embodiments, the plug may be a cigarette lighter plug.

In some embodiments, the vehicle power socket may include a cigarette lighter socket.

In some embodiments, the plug further may include a USB socket.

In some embodiments, the plug may include a connection sensor and the clamping mechanism comprises a control circuit and power storage, and the control circuit may be responsive to the sensor to prevent the lock from unlocking the clamping mechanism when power is not present in the cable and when the connection sensor senses disconnection of the plug.

In some embodiments, the plug may have a locking mechanism to prevent easy removal of the plug from the vehicle power socket.

In some embodiments, the plug may provide a further plug for a further socket, and the cable may be solidly connected to the plug.

In some embodiments, the cable may be solidly connected to the frame.

In some embodiments, the frame may include a charging port for charging the device using power from the cable.

In some embodiments, the holder may be connectable to the vehicle to obtain information regarding the speed of the vehicle.

In some embodiments, the holder may include a radio-frequency identification mechanism for identifying the device.

Another broad aspect is a holder for securing a phone, smartphone or tablet device while driving in a vehicle. The holder includes a frame for supporting or containing the device; a cable terminating in a plug connectable to a vehicle power socket for receiving power when a vehicle is turned on; a lock for securing the device in the holder; an actuator controlled by power from the cable for preventing the lock from releasing the device when power is present in the cable.

In some embodiments, the lock may include at least one clamp and at least one support for locking the device from sides thereof, the holder having a mounting for connecting to a vehicle.

In some embodiments, the plug may include a connection sensor and the lock may include a control circuit and power storage, and the control circuit may be responsive to the sensor to cause the actuator to prevent the lock from releasing the device when power is not present in the cable and when the connection sensor senses disconnection of the plug.

In some embodiments, the plug may have a locking mechanism to prevent easy removal of the plug from the vehicle power socket.

In some embodiments, the plug may be a cigarette lighter plug.

In some embodiments, the plug further may include a cigarette lighter socket.

In some embodiments, the plug may include a USB socket.

In some embodiments, the plug may provide a socket for a further plug, and the cable may be solidly connected to the plug.

In some embodiments, the cable may be solidly connected to the frame.

In some embodiments, the frame may include a charging port for charging the device using power from the cable.

Another broad aspect is a method of securing a phone, smartphone or tablet device while driving in a vehicle. The method includes connecting a cable to a vehicle power socket for receiving power when a vehicle is on and not receiving power when the vehicle is off; placing the device in a frame with a socket that is shaped to receive at least part of the device, the frame having a clamping mechanism for securing the device in the socket, the clamping mechanism connected to a lock; putting the vehicle in a first state, the entering the first state resulting in the lock locking the clamping mechanism, wherein the device is secured in the frame and cannot be removed from the frame when the clamping mechanism is locked; putting the vehicle in a second state, the entering the second state causing the lock to unlock the locked clamping mechanism, wherein the device is removable from the frame when the clamping mechanism is unlocked; and removing the device from the frame.

In some embodiments, the holder may include mounting the frame for supporting the device on or near a vehicle dash so that a screen of the device is visible to a driver.

In some embodiments, the connecting a cable may include locking the plug in the vehicle power socket using a lock mechanism.

In some embodiments, the first state may be entered when the vehicle is turned on and wherein the second state may be entered when the vehicle is turned off.

In some embodiments, the first state may be entered when the vehicle is detected as travelling above a designated speed and wherein the second state is entered when the vehicle is detected as travelling at or under the designated speed.

In some embodiments, the first state may be when the vehicle is detected as going over a designated revolutions per minute, and the second state is when the vehicle is detected as going at or under the designated revolutions per minute.

In some embodiments, the method may include detecting the presence of the device in the frame.

In some embodiments, the method may include creating log information comprising the time at which the vehicle has entered the first state and when the vehicle has entered the second state.

In some embodiments, the created log information may include creating the time at which the presence of the device is detected in the frame.

In some embodiments, the method may include accessing the log information via one of a remote computer and the device.

In some embodiments, the accessing may include transmitting the log information via a transmission device on-board the vehicle.

Another broad aspect is a method of securing a phone, smartphone or tablet device while driving in a vehicle. The method includes connecting a cable terminating in a plug connectable to a vehicle power socket for receiving power when a vehicle is turned on and not receiving power when the vehicle is off; placing the device in a frame adapted for supporting or containing the device, the frame having a lock for securing the device in the holder, the lock being controlled by an actuator controlled by power from the cable for preventing the lock from releasing the device when power is present in the cable; locking the device in the holder such that the device cannot be hand held while the vehicle is turned on; turning the vehicle off so as to permit the actuator to allow the device to be removed from the frame for supporting or containing the device in the holder; and removing the device from the holder.

In some embodiments, the method may include mounting the frame for supporting the device on or near a vehicle dash so that a screen of the device is visible to a driver.

In some embodiments, the connecting a cable may include locking the plug in the vehicle power socket using a lock mechanism.

Another broad aspect is a holder for securing a phone, smartphone or tablet device while driving in a vehicle. the holder includes a frame for supporting the device comprising a base or socket shaped to receive at least a portion of the device; and a clamping mechanism configured to secure the device in the socket; a locking mechanism connected to the clamping mechanism, the locking mechanism comprising a motor actuating a driving member to engage and disengage a driven member of the clamping mechanism to cause the clamping mechanism to lock while tightening its grip on the device and to unlock while loosening its grip on the device.

In some embodiments, the clamping mechanism may travel along an axis perpendicular to the base to tighten its grip on the device or to loosen its grip on the device.

In some embodiments, the locking mechanism may include a rack and pinion.

In some embodiments, the holder may include a connector adapted to connect to a port of the vehicle and to receive power from the vehicle via the connection.

In some embodiments, the connector may be adapted to connect to a USB port of the vehicle.

In some embodiments, the clamping mechanism may include a spring to assist with the positioning of the clamping mechanism when transitioning between locking and unlocking its grip on the device.

In some embodiments, the clamping mechanism may be connected to a control circuit receiving a locking signal from a user as a function of input received at a user input interface, where the user input interface may be configured to receive press input from a user.

In some embodiments, the holder may include a control circuit connected to the locking mechanism, the control circuit configured to receive an indication of a state of a vehicle, wherein the control circuit may cause the locking mechanism, when the vehicle is in a first state, to lock the clamping mechanism so that the device is secured and cannot be removed from the holder, and when the vehicle is in a second state, to unlock the clamping mechanism so that the device is free to be removed from the holder.

Another broad aspect is a holder for securing a phone, smartphone or tablet device while driving in a vehicle. The holder includes a frame for supporting the device including a base or socket shaped to receive at least a portion of the device; and a clamping mechanism configured to secure the device in the socket; a wireless interface adapted to allow the holder to establish wireless communication with a remote server, and at least one of transmitting data to and receiving data from the remote server; a clock; a GPS receiver adapted to receive geolocation data and time data; computer-readable memory; and a controller configured to access the memory and to receive log information regarding an event from a sensor adapted to detect the presence of a device in the base or socket; the vehicle regarding a state of the vehicle; and/or the GPS receiver regarding a state of the vehicle; wherein the controller may be further configured to associate the log information with temporal information corresponding to the time of the event in accordance with the time data and position information in accordance with the geolocation data.

In some embodiments, the time of the clock may be set as a function of the time data received via the GPS receiver.

In some embodiments, the position information may include speed information of the vehicle.

In some embodiments, the position information may include the geolocation of the vehicle.

In some embodiments, the controller may be configured to receive log information regarding an event from the vehicle regarding a state of the vehicle transmitted via the wireless interface.

In some embodiments, the state includes the vehicle is turned on; and/or the vehicle is turned off.

In some embodiments, the controller may be configured to receive log information regarding an event from the GPS receiver regarding a state of the vehicle.

In some embodiments, the state may include the vehicle travelling at a speed above a given threshold; and/or the vehicle travelling at a speed below a given threshold, wherein the speed of the vehicle may be determined as a function of the geolocation data.

In some embodiments, the holder may include a locking mechanism configured to lock the clamping mechanism when the vehicle is in a first state and to unlock the clamping mechanism when the vehicle is in a second state.

In some embodiments, the holder may include an override user input interface configured to receive input from a user to cause the unlocking of the clamping mechanism, the input received by the controller, wherein the controller may be further configured to cause the locking mechanism to unlock the clamping mechanism when the vehicle is in an overridable state.

In some embodiments, the overridable state may be when the vehicle is travelling at a speed under a given threshold speed.

In some embodiments, the override user input interface may be a button.

In some embodiments, the wireless interface may be adapted to establish a connection with a wireless modem of the vehicle and to establish the wireless communication with the remote server via the wireless modem of the vehicle.

In some embodiments, the wireless interface may be adapted to establish the wireless communication with the remote server via a wireless mobile data connection module of the device.

In some embodiments, the holder may include a connector to connect to a port of the vehicle and to receive power via the connection.

In some embodiments, the connector may be adapted to connect to a USB port of the vehicle.

In some embodiments, the connector may include a cigarette lighter socket.

In some embodiments, the temporal information may be generated only when the GPS receiver is receiving the time data, wherein the clock may be set when the GPS receiver is receiving the time data.

In some embodiments, the controller may be further configured to transmit to the remote server via the wireless interface the log information with the temporal information and the position information.

In some embodiments, the controller may be further configured to not transmit to the remote server via the wireless interface the log information with the temporal information and the position information when the GPS receiver is not receiving geolocation data and time data.

Another broad aspect is a holder for securing a phone, smartphone or tablet device while driving in a vehicle. The holder includes a frame for supporting the device including a base or socket shaped to receive at least a portion of the device; and a clamping mechanism configured to secure the device in the socket; a locking mechanism configured to lock the clamping mechanism when the vehicle is in a first state and to unlock the clamping mechanism when the vehicle is in a second state; a wireless interface configured to establish a short-range wireless connection with the smartphone; a user input interface configured to receive input from a user; and a controller configured to, following the reception of input from the user on the user input interface, generate and transmit a signal via the wireless interface to cause the smartphone to accept an incoming call when the smartphone is receiving the incoming call.

In some embodiments, the user input interface may be a button.

In some embodiments, the holder may include a speaker, wherein once the incoming call has been accepted, and an incoming audio signal corresponding to the call may be transmitted from the smartphone to the holder via the wireless connection, audio corresponding to the incoming audio signal is output via the speaker.

In some embodiments, the holder may include a microphone configured to receive vocal input from the user, and wherein the vocal input may be transmitted as an outgoing audio signal over the wireless connection to the smartphone when the incoming call has been accepted by the user.

In some embodiments, the short-range wireless connection may be a Bluetooth connection.

### BRIEF DESCRIPTION OF THE DRAWINGS

The invention will be better understood by way of the following detailed description of embodiments of the invention with reference to the appended drawings, in which:

FIG. 1A is a schematic drawing of an exemplary smartphone holder of the type having side clamps and a bottom ledge support for retaining the smartphone while driving, the holder being mounted to the dashboard or window of the vehicle;

FIG. 1B is a schematic drawing of an exemplary smartphone holder of the type having a top clamp and a bottom ledge support for retaining the smartphone while driving, the holder being mounted to the dashboard or window of the vehicle;

FIG. 1C is a side view of the embodiment of FIG. 1B with the top clamp lowered and the holder not holding a smartphone;

FIG. 1D is a side view similar to FIG. 1C showing a smartphone held in the holder with the top clamp securing a top edge of the smartphone;

FIG. 1E is a front view of the embodiment of FIG. 1B showing the smartphone held by the holder;

FIGS. 1F and 1G show details of the motor with the rack and pinion locking mechanism according to the embodiment of FIG. 1B, wherein FIG. 1F shows the locking mechanism in the unlocked state and FIG. 1G shows the locked state;

FIG. 2A is a schematic drawing of a USB type A connector in a first position that includes a connection detection pin switch;

FIG. 2B is a schematic drawing of a USB type A connector in a second position that includes a connection detection pin switch;

FIG. 3 is a side sectional view of a cigarette lighter type 12V DC vehicle plug and socket arrangement that includes a locking mechanism and USB charging port; and

FIG. 4 is a front view of the arrangement of FIG. 3.

FIG. 5A is a front perspective view of another exemplary smartphone holder, with a smartphone, with a clamping mechanism that is positioned on the top of the holder, and where the supports form a socket that receives at least part of the smartphone.

FIG. 5B is a front perspective view of another exemplary smartphone holder with a clamping mechanism that is positioned on the top of the holder, and where the supports form a socket that receives at least part of the smartphone.

FIG. 6 is a block diagram of an exemplary log system of an exemplary smartphone holder.

FIG. 7 is a flowchart diagram of an exemplary set of steps of securing a smartphone in a vehicle.

### DETAILED DESCRIPTION

A smartphone, mobile phone or tablet device holder is described in the present application where the holder has a frame with a socket for receiving at least part of a phone and a clamping mechanism for securing the phone to the frame. The clamping mechanism is connected to a lock. The lock may lock the clamping mechanism so that the phone cannot be removed from the holder. When the lock unlocks the clamping mechanism, the phone may be removed from the holder. The lock responds directly or indirectly to a signal received from the vehicle indicative of the vehicle changing states, the response of the lock to the signal being the locking or unlocking of the clamping mechanism.

By the “state of the vehicle”, it is meant if the vehicle is turned on or off, if the vehicle is detected as travelling above, at or below a designated speed, if the vehicle is in a certain gear, if the vehicle is above, at or below a given RPM, etc.

In the present application, the holder may be used to secure a mobile computing device, such as a tablet device, mobile phone, smartphone, etc.

By “vehicle” it is meant a conveyance for transporting people or goods, such as a car, jeep, van, truck, four by four, cart, etc., or that are operated or driven by a person such as heavy equipment, heavy machinery, cranes, heavy machines, heavy trucks, construction equipment, engineering equipment, heavy vehicles, or heavy hydraulics, etc. In some examples, a vehicle may also be a boat, a motorboat, a plane, etc.

In the present application, reference is made to a device that can be secured to the holder when driving. Such a device may be, for instance, a phone, smartphone or a tablet device. In the present description, as an exemplary embodiment, reference is made to a smartphone. However, it will be understood that any other device, such as a phone, smartphone or a tablet device, may be secured to the holder without departing from the present teachings.

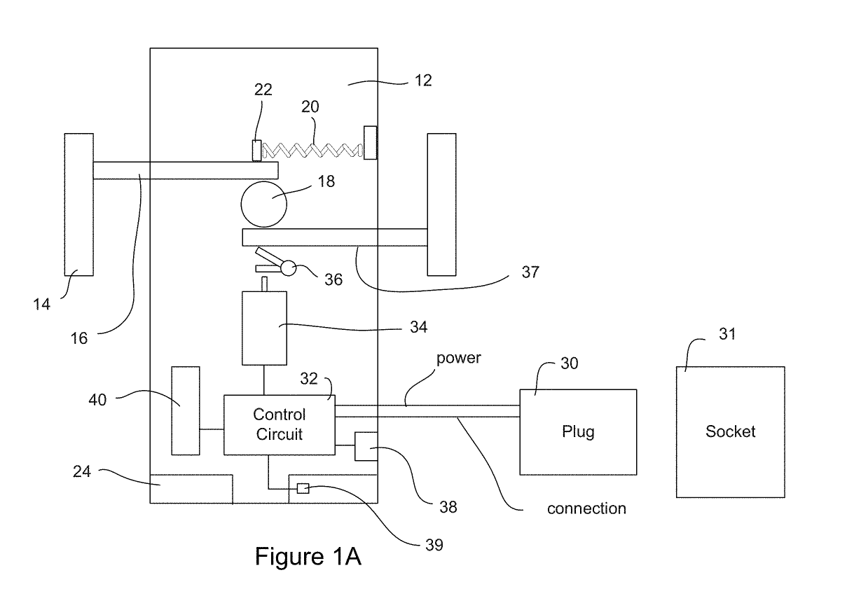

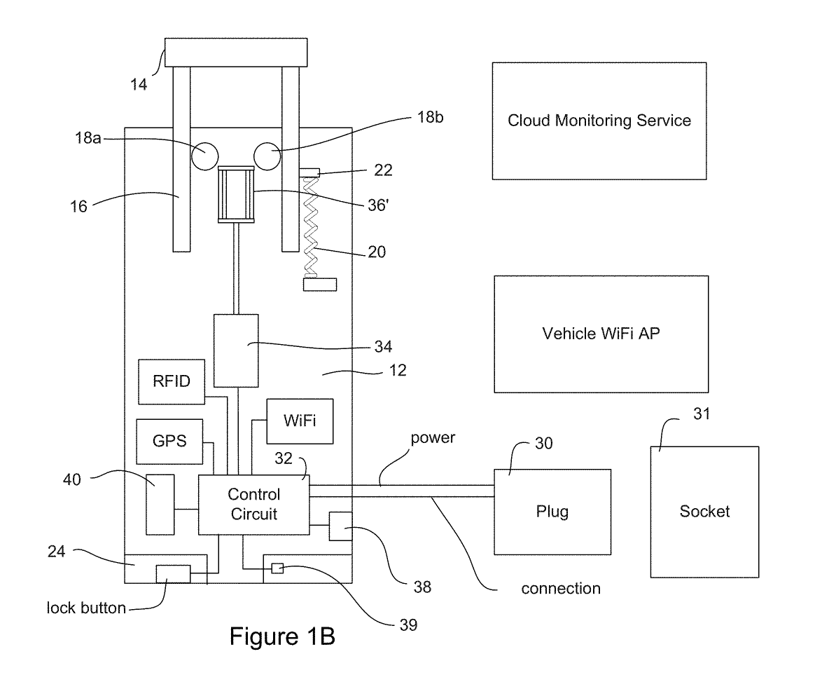

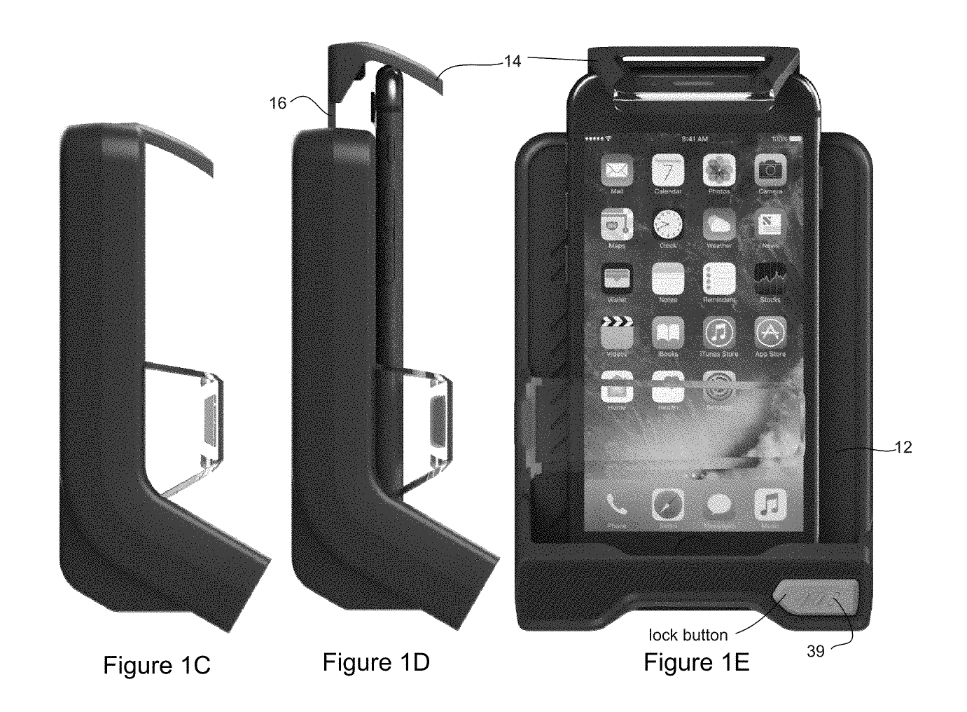

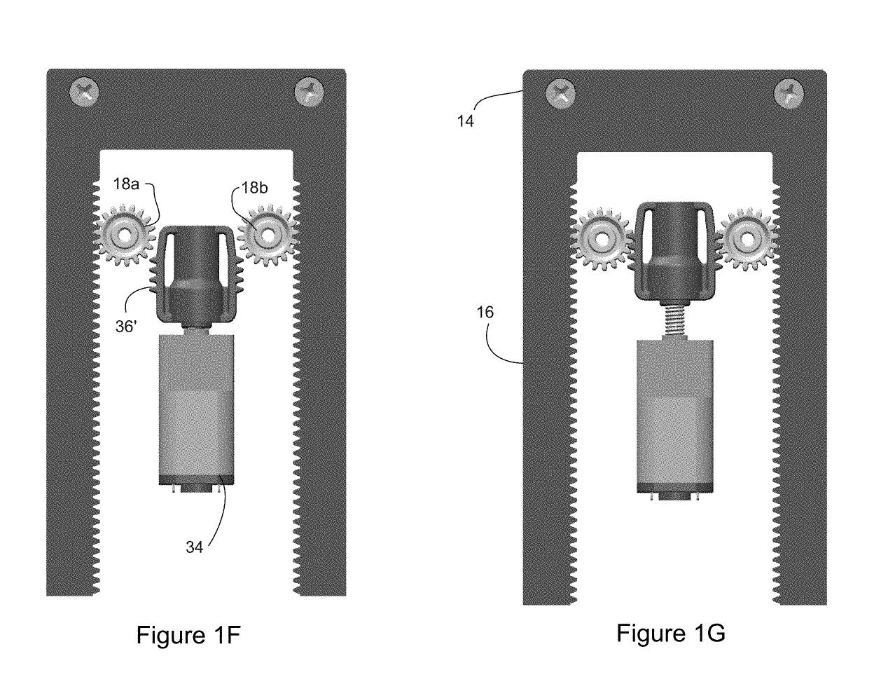

FIG. 1A illustrates schematically an embodiment in which a smartphone holder 12 has, as a clamping mechanism, side clamps 14 that conform to vertical sides of a smartphone. The clamps 14 can be mounted on slides 16 with a gear rack and interconnected by a gear 18 seated in the frame of holder 12. The slides 16 can be biased outwardly using, for example, a spring 20 or other elastic member connected between holder 12 and a mounting 22 on slide 16.

The smartphone may be placed in a frame with a socket for receiving at least part of the smartphone. The socket may be defined by supports 24 for supporting the bottom of the smartphone, where the supports 24 may be positioned on each side of the bottom of the holder 12. The smartphone can be secured by clamps 14 while being supported at the bottom by supports 24.

A locking mechanism is provided, for example an actuator 34 that controls a pawl 36 that engages against a rack 37. Electrical control over the actuator 34 can be provided by a control circuit 32 that receives power from the vehicle via a plug 30 connectable to a socket 31 of the vehicle. A power connector or cable 38 can be provided to allow the power from plug 30 to be used to charge the smartphone in the holder 12.

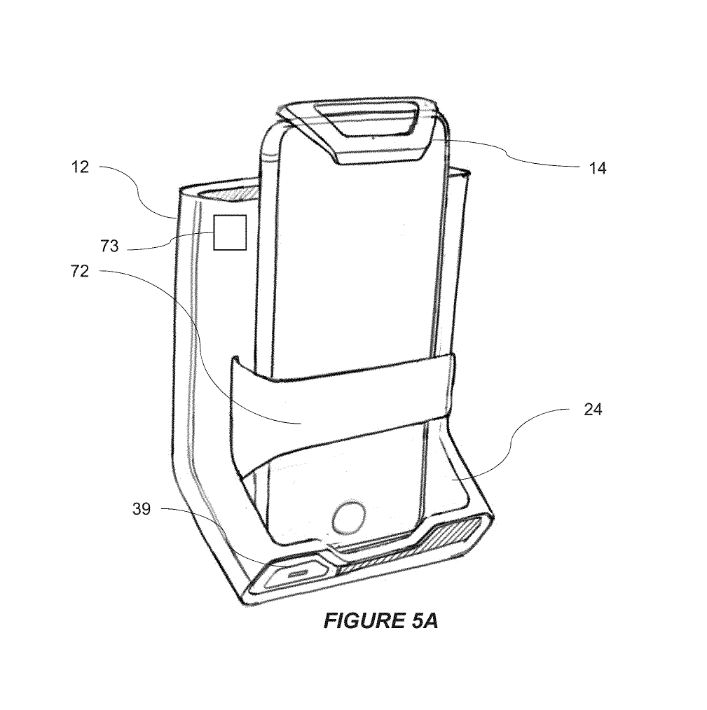

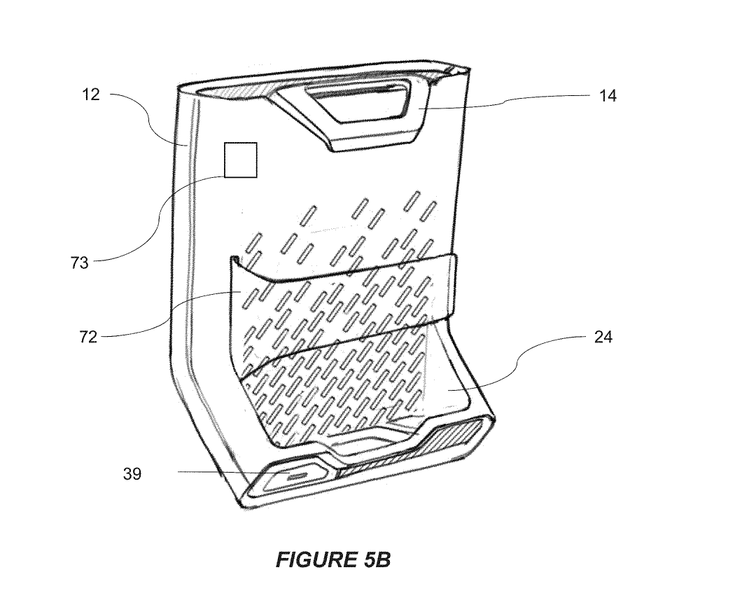

It will be appreciated that a smartphone or tablet holder 12 can use clamps that move vertically and/or that hold the device from various corners and/or from mounting posts or grooves associated with a frame of the device. As shown in FIGS. 5A and 5B, the clamping mechanism 14 may instead have a clamp 14 that is configured to secure, and may clamp down, onto the top portion of the phone (e.g. as illustrated in FIG. 1B to 1G). The clamp 14 may also be mounted on slides 16 where it may be adjusted vertically to different smartphone sizes, and then clamp down onto the top of the smartphone. The bottom of the smartphone may be held in the socket, where the supports 24 form the socket with walls contouring at least a portion of the base of the smartphone so that the smartphone may not be removed from the socket once the clamp 14 has clamped down onto the smartphone. When the lock locks the clamping mechanism, the smartphone 12 can no longer be removed from the holder 12 until the clamping mechanism is unlocked.

The holder 12 includes a mounting (not shown for ease of understanding in FIG. 1A) that can be of conventional construction for mounting the holder 12 to the vehicle. Typically, these mountings include (without limitation herein) windshield suction cup mountings, dashboard top panel mountings that have a portion adhesively connected to the dashboard top panel, and air vent clip mountings.

In FIG. 1A, the holder 12 is enhanced with control over the locking mechanism. The actuator 34 can cause the pawl 36 to be biased against the rack 37 when power from the vehicle's auxiliary power is turned on using the vehicle ignition. Closing the clamps 14 locks the device in place on the holder 12. The objective is to give the driver a voluntary tool to secure the device at the beginning of a drive and then to provide a reminder that the device should not be hand held while driving by making it more difficult to access for hand held use. Therefore, the smartphone is locked into the holder when the vehicle enters a first state, but the smartphone may be unlocked from the holder when the vehicle enters a second state. For instance, the state of the vehicle may be when the vehicle is turned on or turned off. In some examples, the state of the vehicle may depend upon the speed of the vehicle, where detecting that the vehicle is travelling above a certain speed may trigger the locking of the holder. Moreover, detecting that the vehicle is travelling at or under a certain speed may trigger that the holder is unlocked. For example, the state of the vehicle may be set as a function of speed for truck drivers, where a truck driver's vehicle may be frequently left in idle. Therefore, it may not be advantageous to define the states of the vehicle as a function of the truck being turned on or off. For example, the truck driver may have to use his smartphone when the truck is idle so it may not be advantageous to lock the device as soon as the vehicle is running. Instead, the state may be defined by if the truck is travelling, for instance, at a speed over 0 miles per hour.

In some examples, the speed may be detected as a function of the readings generated by the vehicle ((e.g. obtained from the vehicle when connected, for instance, to the controller area network (CAN bus)), or by, for instance, a GPS of the smartphone, the vehicle or of another device.

In the examples where the state of the vehicle relates to the vehicle being turned on or off, release of the device from holder 12 may be achieved by turning off the vehicle that cuts power to the control circuit. While it is possible to use a solenoid controlled latch that allows release of the pawl mechanism when power is cut to the solenoid, the embodiment of FIG. 1A illustrates that a power source 40 (for example a battery or a capacitor) can be used to power the actuator when power is interrupted. In this way, the actuator 34 need not consume any standby power when in use. In some examples, the holder 12 does not have a power source 40, where the holder 12 may, for instance, receive its power via its connection with the vehicle.

The embodiment of FIG. 1B shows a different exemplary locking mechanism that is also illustrated less schematically in FIGS. 1F and 1G. As shown, the motor 34 turns a screw shaft that moves a corresponding nut of a rack member 36′ linearly between an engaged position and a disengaged position. Pinion gears 18a and 18b engage a rack surface of each holding arm 16. In this embodiment, the clamp member 14 is a single top clamp instead of two side clamps. It will be understood that the locking mechanism illustrated can be applied to one or both side clamp members 14 in a configuration similar to FIG. 1A. To improve meshing, the rack member 36′ has flexible sides that can bend as they engage the pinion gears 18a and 18b.

In the unlocked state shown in FIG. 1F, the pinions 18a and 18b are free to rotate and the members 16 move under the action of the spring 20 (see FIG. 1B). The spring 20 is entirely optional, since in the unlocked state, the member 14 can be lifted and lowered freely. Gravity will cause the top clamp 14 to fall into a lowered position. The use of the spring 20 can be useful to ensure that the clamp is in a desired position when the lock is open. The user can place a smartphone in holder 12 with the clamp 14 resting on the top of the phone. In some examples, the motor 34 is actuated in response to a lock button that the user can press. The control circuit 32 receives the lock button signal and actuates the motor accordingly. This can be done using a timer, motor rotation encoder or limit switches associated with the member 36′ as desired. In some embodiments, the motor may be actuated when the vehicle is turned on, shifted into a designated gear, reaches a designated speed as registered, for example, on the speedometer, etc. When the motor 34 moves the member 36′ to engage the pinions 18a and 18b, the members 16 constrict the smartphone (the state of FIG. 1G). A resilient member can be incorporated into the clamp 14 or into the member 36′ to provide compliance during this constriction or compression. The screw drive prevents the clamp 14 from loosening without using a brake or pawl mechanism as was the case in FIG. 1A.

In the embodiment of FIGS. 1B to 1G, a rack and pinion engagement is used to lock the clamp 14 while providing a small tightening of the clamp's grip during the locking. It will be appreciated that this mechanism can be embodied differently. For example, a friction drive mechanism can be used instead of gearing, for example, member 36′ and pinions 18a and 18b can have high grip surfaces so as to allow the desired drive. For example, member 36′ can be made of a rubber-like material. It is possible to configure the member 36′ to provide resiliency that can reduce the need for a resilient pad within clamp 14 as the locking mechanism applies added clamping force to the smartphone held in holder 12. The drive of the members 16 can be geared or likewise use a frictional coupling. Alternatively, the member 36′ can be arranged to move along a curved path so that it engages as a moving pawl against the rack of the members 16, with the member 36′ being driven to pull the clamp 14 in the desired locking direction.

As will be appreciated, the locking mechanism of FIGS. 1B to 1G provides a locking mechanism that can increase the clamping force on the smartphone when locking the clamp.

Because the holder 12 has as its primary purpose to help a driver comply with non hand-held use of a smartphone while driving, it can suffice to have plug 30 connect into a vehicle socket 31 without any measure to detect and to respond to power loss through the driver unplugging of the plug 30. Such unplugging to defeat the lock mechanism of the holder 12 would be an act going against the voluntary compliance involved, and most drivers will not actively defeat the system. However, a number of options are available to make compliance more difficult to defeat.

In some examples, as shown in FIGS. 5A and 5B, the holder 12 may also have a screen or surface 72 that covers at least a portion of the screen of the smartphone to prevent at least partial use of the screen or keyboard of the device when the smartphone is secured within the holder 12. The screen 72 may also be, in some examples, transparent, in order to allow the user to view the display of the smartphone but not to touch the display of the smartphone directly. In other examples, the screen 72 may be opaque. The screen 72 may also assist with the securing of the smartphone to the holder 12.

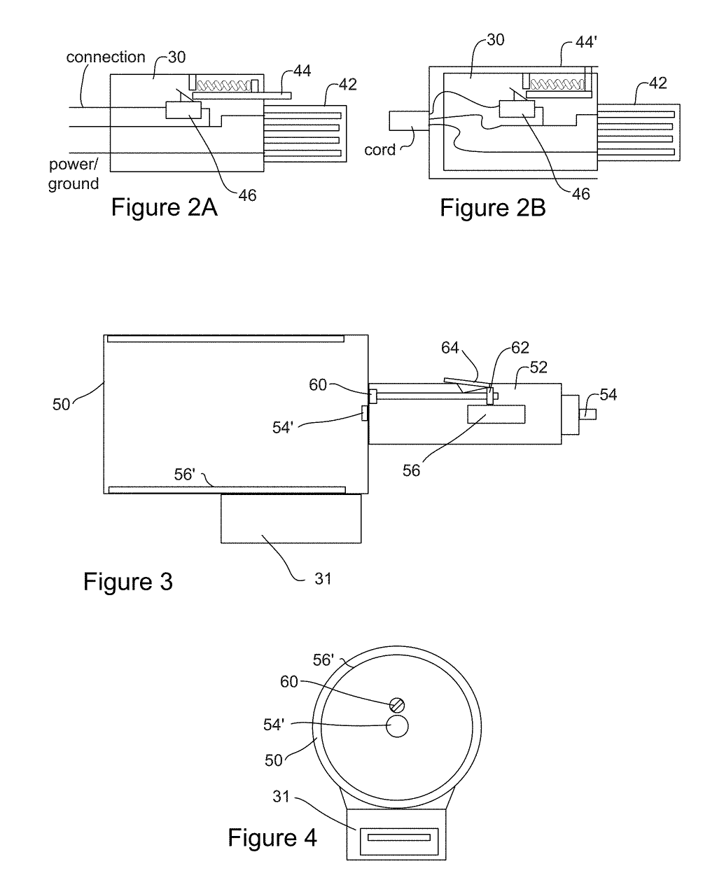

FIG. 2 illustrates one such option. A USB type A connector 30 is modified to have next to its conventional sheath 42 a pin 44 that is biased outward and depresses a switch 46 when fully connected into its socket 31. The switch connection is connected to a connection conductor that follows the power cable from the plug 30 to the control circuit 32. Since pin 44 can detect removal before the contacts of the connector 30 disconnect from the corresponding contacts of socket 31, pin 44 is effective to detect tampering. If the pin 44 senses that the plug 30 is being removed from socket 31, then the control circuit will not cause the pawl 36 to release the clamps 14. Optionally, circuit 32 can cause LED indicator 39 (or an audio signal indicator) to warn the driver that the plug 30 is disconnected, and that the holder 12 will remain locked until the plug 30 is reconnected and vehicle power is turned off. LED 39 can be a multicolor LED and use different colors to signal different states. The release of the clamp or clamps 14 can be automatic when vehicle auxiliary power is off, or release can require the drive to press a release button (not shown). Plug 30 illustrated in FIG. 2 can be used with any conventional USB socket 31 found in the vehicle whose power state is controlled by the vehicle's ignition state.

The indicator 39 can also be used by control circuit 32 to signal to the driver when starting the vehicle that the phone or tablet should be clamped into the holder 12. For example, indicator 39 can flash for a period when power is initially applied to circuit 32. If the holder 12 is equipped with a sensor for the presence of the phone or tablet in the holder (or that the clamp mechanism is not open), then the indicator 39 can turn off once the phone or tablet is secured in the holder 12. Control circuit 32 can also cause the indicator 39 to signal when vehicle power is off, and the phone can be removed from the holder 12. This signal can be a number of flashes to attract attention briefly, or in the case of an audio indicator, a short beep or an audible alarm.

The holder 12 can also be equipped with a sensor 115 for detecting that the phone is present in the holder 12. The sensor 115 can, for example, be a button switch that is depressed by the phone when held by the holder, a switch associated with the position of the slides 16, or an optical detector (light emitter and detector) that detects the phone when in the holder 12. The control circuit 32 can also be arranged to provide using indicator 39 a signal specifically when the phone is absent from the holder at vehicle start up and/or when the phone is present in the holder at vehicle shut down. The sensor 115 may be a proximity sensor 115 as is known in the art.

In the case that a vehicle does not have an available USB socket 31, a conventional 12V DC cigarette lighter plug to USB socket adapter could be used, however, the adapter could be removed with the plug 30 as shown in FIG. 2, and the removal detection pin 44 would be defeated. To avoid any such problem, the embodiment of FIGS. 3 and 4 can be used. The plug 52 fits into a cigarette lighter socket of a vehicle with pin 54 and tab 56 being connectable to 12V DC power contacts of the vehicle socket. To make removal of the plug 52 difficult by the driver, a locking mechanism is included that includes a screw 60 having a nut 62 that moves a tab 64 to press against an inside of the vehicle socket to make removal of the plug 52 very difficult. An external 12V DC socket 50 is provided that provides corresponding socket contacts 54′ and 56′ connected to contacts 54 and 56 respectively. This allows for the adapter to be locked into the vehicle's socket, while providing the driver with the external socket for use with another plug. A USB type A socket 31 is provided on the socket 50 for use with holder 12. While this socket 31 can be used with the connector 30 as illustrated in FIG. 2, it is available for other purposes as well.

While reference is made herein to USB type A, it will be appreciated that the format of the connector can be varied as desired to be a different type of USB connector, or a connector of different kind, such as the Apple Lightning connector, an HDMI type connector, etc. While power taken from a vehicle socket is described above as being from a cigarette lighter type socket or a USB socket, it will be appreciated that a vehicle fuse socket is also an easy way to connect into vehicle auxiliary power. In some examples, the connector may be configured to connect with a car computer port, such as a computer diagnostics port of the vehicle (e.g. an OBD-II port of the vehicle).

It will be appreciated that instead of using a conventional plug and socket connection to bring the power connection to holder 12, a fixed cable can be used. For example, a plug of the type shown in FIG. 3 can be used to connect to the vehicle socket, while a fixed cable can extend from the plug 52 to the holder 12. Such a plug 52 can provide socket 50 or only a socket 31, like a conventional USB adapter for a vehicle. The fixed cable can be a thin cable if powering only holder 12 (less than 1 A capacity), or it can be more robust to carry a higher current to power port 38.

In some examples, the holder, connected to the vehicle as explained herein, may detect when the vehicle enters a first state (e.g. ignition key is turned “on”; the vehicle's RPM goes over a certain designated threshold). It may then also detect the presence of the smartphone in the holder, such as via the sensor of the holder to detect the phone, or when a user presses a “lock button” as illustrated in FIG. 1B. In the example where the first state is when the ignition key is turned to “on”, If the ignition key is turned “on” but the phone is not detected to be present in the holder, the indicator may produce a signal to advise the driver to add the phone to the holder. Once the phone is introduced into the holder and the ignition key is turned on (or the vehicle is in the first state), then the holder, via the lock and the clamping mechanism, may secure the phone to the frame of the holder. Once the vehicle enters the second state (e.g. the ignition key is removed and/or the vehicle is turned off), the user may remove the phone. The indicator may also signal the user that the phone may be removed from the holder. Moreover, the indicator may also provide an indication in the case of an accident that the phone was present in the holder at the time of the accident (e.g. the vehicle comes to a stop, the ignition key is still present, and the phone is in the holder) by, for instance, producing a different colour of light (e.g. a different colour of a flashing light) or by producing a different audible alarm signal, etc.

In some embodiments, the holder 12 may have an orientation or tilt sensor 73, as is known in the art, in order to detect the orientation or inclination of the phone in the holder 12, (e.g. if the phone is positioned vertically or horizontally). In some embodiments, where the holder 12 has a screen or surface to obstruct at least a portion of the display of the phone corresponding to the keyboard of the phone, the tilt sensor 73 may detect when a driver tilts his phone, or the phone is positioned in a horizontal position, while driving, in order to, for example, attempt to text. Upon detection of the titling of the phone by the tilt sensor 73, the holder may provide a signal to the driver indicative of the driver's non-compliance by tilting the phone (e.g. an audible alarm; a visual indication such as a flashing light). In some examples, a logging system 100, as described herein, may be in communication with the tilt sensor 73 in order to create log events for when the phone is titled.

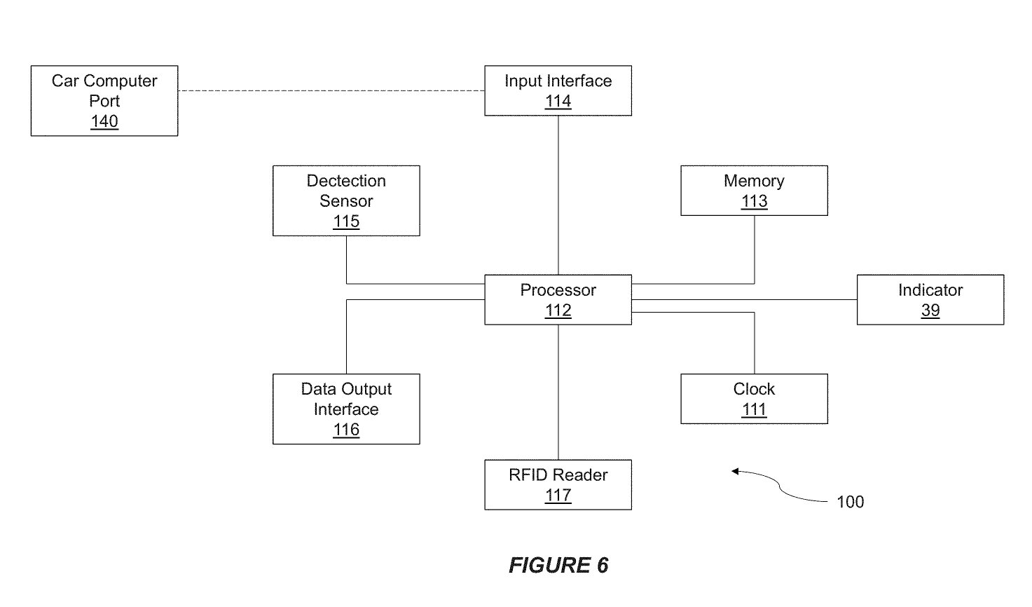

Reference is now made to FIG. 6, illustrating an exemplary logging system 100 for a smartphone holder 12. The logging system 100 may create entries of the times where the smartphone is present in the holder 12, and when the car is in a first state and a second state. These entries may, in some embodiments, be stored in memory (e.g. the memory of the holder, or an external memory). The log may be transmitted following its creation, stored, and/or consulted at a later time, for instance, after an accident, to verify if the smartphone was properly secured in the holder 12 during the time of the accident, when the vehicle was in use. The log information may also provide compliance information to a manager of a fleet of trucks regarding a particular driver and the driver's use of the holder while driving, or to an employer monitoring compliance of its employee(s) to lock the phone away in the holder when driving the vehicle. Therefore, the log may also store time entries regarding when the vehicle enters a defined state (e.g. goes over, at or under a certain speed, is turned on or turned off, detects a gear shift to “drive”, to “park”, etc.). In some examples, the log system may be in communication with a transmission device (e.g. a telemetry device) that sends and/or stores vehicle parameters that are accessible by a remote user, such as an employer or manager/or owner of vehicles.

The log system 100 has a general-purpose processor 112. The log system 100 may have a computer readable-memory 113. The log system 100 may have a clock 111 and a data output interface 116. The log system 100 may also interact with the indicator 39 of the holder 12, an RFID reader 117 of the holder 12 and/or a detection sensor 115 of the holder. The log system 100 may also have an input interface 114 for receiving information on the vehicle via a cable connected to vehicle computer port 140 or power socket of the vehicle.

The processor 112 may be a general-purpose programmable processor 112 such as a micro-processor.

The memory 113 stores program instructions and data used by the processor 112. The memory 113 may store the logs, including the time entries associated with the logs. The memory 113 may have a recycling architecture, where older files may be deleted when the memory is full or nearly full, or have been stored for a certain period. The processor 112 may be connected to the memory 113 via a BUS. The memory 113 may be part of the holder 12, or may be or also include an external memory, such as that of a transmission device as described herein. The memory may also be that of a remote computer, where the information is sent directly or indirectly to the remote computer and stored thereon.

The clock 111 is capable of providing temporal information, such as the time and date. The temporal information is then stored by the processor 112 with each log or event (e.g. detection of smartphone, change of state of vehicle) in memory 113. In some examples, the log holder 12 may have its own clock 111. In other examples, the clock 111 may be that of the vehicle, where the information is communicated to the processor 112 via the connection with the car, such as the information received by the input interface 114 receiving information via the cable connected to the car computer port 140. In other examples, the clock 111 may be that of the smartphone, where, for instance, the temporal information may be sent to the holder 12 via a connection with the phone (e.g. the charging port of the holder of the smartphone through which the smartphone is connected).

The sensor 115 is to detect the presence of the smartphone 115 (or the absence thereof) in the holder 12. The RFID reader 117 is to identify a specific smartphone 12, where the smartphone 12 may have a RFID chip. The RFID reader 117 may be one as is known in the art. In some examples, where the RFID reader 117 is placed on or near the holder 12, the RFID reader 117 may also act as the proximity sensor 115, where the RFID reader 117 may require that the smartphone be in proximity in order to detect the smartphone. Therefore, in this example, the RFID reader 117 identifies the smartphone when the smartphone is in proximity to the RFID reader 117, where a positive detection may also act as an indication that the smartphone 12 is in proximity of the holder 12. Even though reference is made to an RFID reader, any other suitable mechanism to identify the smartphone may be used in accordance with the present teachings.

In some examples, the holder 12 may also be configured to have a wireless charger to wirelessly transfer power to the smartphone, charging the smartphone when the smartphone is placed on the holder 12.

In some examples, the holder 12 may have a wireless interface for establishing a wireless connection (e.g. a Bluetooth connection) with the smartphone to be placed in the holder 12. The holder 12 may detect the establishment of a wireless connection with the smartphone. The wireless connection may indicate that the smartphone is in proximity to the holder 12, and therefore also to the vehicle. If the vehicle transitions to a first state (e.g. is turned on, has an RPM over a certain amount, travels at a certain speed), and the smartphone is detected to not be present in the holder 12 (e.g. such as by using, for instance, sensor 115), then the holder 12 may provide an indication (e.g. a light signal, an alarm) to signal that the smartphone is not present in the holder when the vehicle enters the first state. It will be understood that other mechanisms and/or combinations to identify whether the smartphone is in proximity to the vehicle and/or to the holder may be used without departing from the present teachings. Moreover, in some embodiments, the log system as described herein may also be in communication with the wireless interface to provide an entry in memory of when the smartphone has established a wireless connection with the holder, and/or when this connection is lost.

The processor 112 receives information from the sensor 115 as to the sensor 115 detecting the presence of an object (or absence thereof). The processor 112 may then store in memory an entry relating to the detection of the object corresponding to the detection of the smartphone 12, where the entry may be stored with the temporal information as obtained from the clock 111.

Moreover, the processor 112 may also be connected to the input interface 114 for receiving information via a connection established with the car computer, through the car computer port 140. The processor 112 may receive information regarding the state of the vehicle and/or vehicle parameters. This state information may then be stored in memory 113 as log entries and/or additional vehicle information. These log entries may be stored with the temporal information as obtained from the clock 111.

In other examples, the log system 100 may be part of the control circuit 32, where the processor 112 may trigger the turning on and off of the indicator 39 as described herein.

The log system 112 may have a data output interface 116. The data output interface 116 may be to establish a wired or wireless connection (e.g. Bluetooth connection, WiFi connection) with a user, device, server or computer in order to provide access to or transmit the log information that has been created (or, in some cases, stored in memory 113). For instance, the data output interface 116 may establish a wireless connection with an external computer through which the log entry information may be accessed and/or transmitted (e.g. the log entry information may be accessed through an application program running on the external computer, or through a website running on the external computer). By external computer, it is also meant a computer or device that is present on-board or in proximity to the vehicle. For instance, the data output interface may establish a connection, wired or wireless (e.g. a Bluetooth connection), with the smartphone that is in the holder. The data output interface may also be wired to a remote computer to similarly access and/or transmit the log entry information. In some examples, the log entry information may be viewed on a display attached or accessible via the holder 12.

In some embodiments, the data output interface 116 may be in communication with a transmission device that is present on-board the vehicle. A transmission device may be, for instance, one that is present on trucks, such as one of a fleet management system, to communicate with a remote or computer (e.g. an employer, a manager of a fleet, etc.). The transmission device may be, for instance, a telemetry device or vehicle information collection device that records parameters of the vehicle (such as, e.g., the ISAAC InMetrics™ Telemetry System or the ORCA™ fleet management device of Geothentic™, or another telemetry or vehicle information collection device) and/or that transmits information on the truck to a remote party to assess, for instance performance, compliance, productivity, etc. The data output interface 116 may establish a wireless connection or a low bandwidth wireless connection with the transmission device (e.g. a Bluetooth connection), and transmit the log information to the transmission device. In turn, the transmission device may store the log information in its memory (e.g. where, in some examples, the memory of the transmission device may be the memory 113 of the log system 100), and/or the transmission device may transmit the information to a remote user, remote server or remote computer via, for instance, a wireless connection (e.g. WiFi connection). The transmission device may also retrieve information, such as the log information, stored in the memory 113 of the holder 12 at certain times, and then transmit the retrieved information remotely to a remote device and/or user. In some examples, the connection between the data output interface 116 and the transmission device may be wired.

In some embodiments, the holder may have an input interface (e.g. the input interface 114, USB port, wireless connection) so that it may receive program instructions to reprogram or update the programming of the architecture of the holder system.

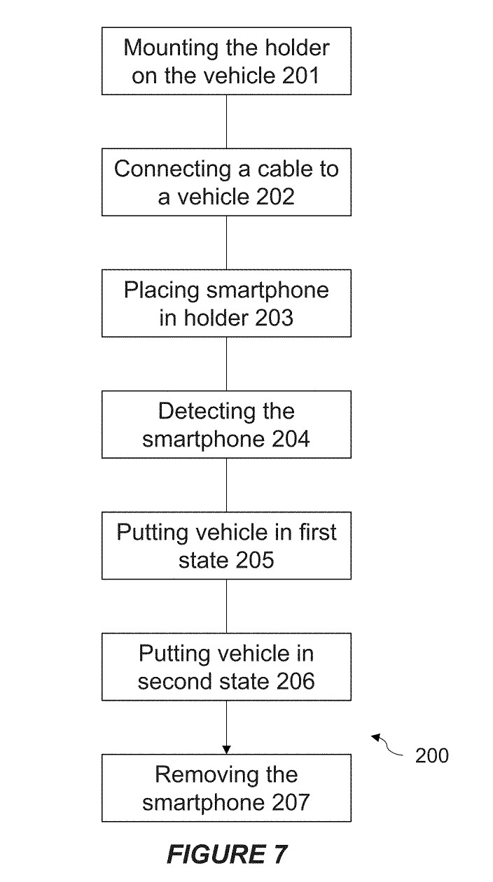

Reference is now made to FIG. 7, illustrating an exemplary method 200 of securing a smartphone (or another device) while driving.

The holder may be first mounted to the vehicle, such as the dashboard of the vehicle at step 201. The holder may be mounted to the vehicle in a location near the driver so that the driver may still view the display of the smartphone while driving, helpful for instance when using a navigation function offered by an application program running on the smartphone.

The holder may then be connected to the vehicle (e.g. the vehicle's computer, vehicle wiring) by connecting a cable to the vehicle at step 202. The cable may be connected to a power socket of the vehicle, such as the cigarette lighter of the vehicle or a vehicle computer port such as an on-board diagnostics port (e.g. OBD-II port). In some examples, the holder may be connected to the controller area network (CAN Bus) of the vehicle in order to, for instance, obtain information on the vehicle's parameters, such as its speed, RPM, etc.

The smartphone is then placed in the frame of the holder at step 203. The smartphone may be placed in the socket of the frame. The clamping mechanism may then secure the phone. In some examples, the clamping mechanism may be handled to allow for insertion of the phone, such as using its sliding mechanism to provide additional room for the smartphone to be inserted into the socket. The clamping mechanism may be slid back so that it clamps down onto the phone, coming into contact with the smartphone and holding it in place.

Optionally, when the holder has a sensor 115, the holder 12 may detect the presence of the smartphone at step 204. This detection of the smartphone may be logged into the memory of the holder with temporal information as described herein.

The vehicle may then enter a first state at step 205, such as the turning on of the vehicle, shifting the vehicle into a designated gear, or passing a designated speed. The entering of the first state may result in the lock of the holder locking the clamping mechanism so that the smartphone cannot be removed from the holder once the clamping mechanism is locked. When the vehicle is turned on, power may be transmitted to the holder to power the holder, including, in some examples, the lock, via the cable connected to the vehicle. Optionally, the entering of a first state may be logged into the memory of the holder with temporal information as described herein.

The vehicle may then be put into a second state at step 206 (e.g. turning off the vehicle, the vehicle speed falling to or below a designated speed, putting the vehicle in a different gear). The entering of the second state causes the lock of the holder to unlock the clamping mechanism. Once unlocked, the clamping mechanism allows for the smartphone to be removed from the holder. Optionally, the entering of a second state may be logged into the memory of the holder with temporal information as described herein.

The smartphone may then be removed from the holder at step 207. Optionally, the detection of the removal of the smartphone by the sensor 115 may be logged into the memory of the holder with temporal information as described herein.

While the embodiments described above illustrate a holder 12 that holds a phone or tablet for non-hand-held use while driving, in other embodiments, the holder can be a container, such as a box or a bag with a lockable closure controlled by actuator 34. Such a container can be opaque or transparent as desired, and can be designed to allow partial use of the phone or to impair use, for example by attenuating or blocking radio functions. A phone storage box with a lockable cover can be stored in a glove compartment or in a storage console of a door or between seats while connected to vehicle power via a cable.

Network Connected Smartphone Holder and Cloud Monitoring Service

For real-time monitoring capability, the holder 12 can connect to a network either directly using its own mobile data modem or it can use the mobile data modem of the vehicle. In the latter case, there may be two options, namely the vehicle provides merely network connectivity or the vehicle's computer interfaces with the holder 12 like a local peripheral and the vehicle's computer stores, interprets and shares the data received from holder 12. The data link between the holder 12 and the vehicle computer can be wired (e.g. the CAN bus) or wireless (e.g. Bluetooth or WiFi). The vehicle computer can be a fleet monitoring device, for example.

In the embodiment of FIG. 1B, there is schematically illustrated that the smartphone holder 12 has wireless connectivity to a remote network, as for example using WiFi or Bluetooth to connect to a wireless modem of the vehicle or alternatively by having a direct wireless connection, as for example using a mobile telephone data connection. Thus, the holder 12 is able to be in communication with a remote server, for example a cloud service that can allow monitoring of compliance regarding usage of the holder 12.

To establish motion of holder 12 independently of the vehicle's sensor data, holder 12 can comprise a suitable motion sensor, such as an accelerometer, e.g. an accelerometer integrated circuit device, or a GPS receiver.

An advance of using a GPS receiver is that it provides a time signal that can be used either directly as a time stamp or to synchronize a local clock of holder 12. In the latter case, the local clock does not need to have a battery back-up to maintain time, since the local clock can be resynchronized when the GPS time signal is received following a power on cycle. The GPS receiver may also provide information that can correspond to, or that can be processed to generate, the geolocation of the vehicle, the speed of the vehicle, etc.

The embodiment of FIG. 1B also illustrates having a GPS chip in holder 12 to collect position data. By having its own ability to judge whether the vehicle is in motion or immobilised using position data readings, holder 12 does not need to be connected to the vehicle's speed or motion data. Control circuit 32 can decide whether the vehicle's motion permits removing the smartphone or tablet from the holder 12. For instance, the holder 12 may provide an override “unlock button”, allowing the user to remove the smartphone from the holder when the vehicle is in a given state. For instance, the state may be when a vehicle is travelling at a speed at or under a given threshold speed, such as when the vehicle is stationary. When the vehicle is in the given state, the pressing of the override unlock button may allow the user to remove the smartphone from the holder 12. The removal of the smartphone 12 may be logged as an event, the log information optionally saved with temporal information and/or position information, in accordance with, e.g., geolocation data and/or time data received from the GPS receiver.

The reporting of compliance can include the identity of the smartphone as can be identified by an RFID sensor or the like. One equivalent of an RFID sensor can be the use of a wireless charger in which the ID of the charging device provides its identifier, such as the Qi-compliant wireless charging model.

In addition to smartphone usage compliance, holder 12 can also report on location and speed for monitoring of the driver's performance and/or behavior.

The data transmitted from holder 12 to the cloud monitoring service (FIG. 1B) can be encrypted for transmission and storage on the cloud. Authorized users, for example a fleet manager, employer or parent, can use a decryption key to see the data regarding the holders 12 that they manage.

Incoming Call Functionality:

In some embodiments, as illustrated in FIG. 1B, the holder 12 may be configured to establish a Bluetooth connection (or any other short range wireless connection), via its wireless interface (e.g. a Bluetooth chip as depicted by “BT” in FIG. 1B), with the smartphone (e.g. pairing the smartphone with the holder). The holder 12 may include a button (e.g. may be the same as the lock button in some examples), or a series of buttons, that allows, once connection to the smartphone has been established, a user to accept and/or decline an incoming call via the holder 12, such as one available via a standard handsfree solution, without physically touching the smartphone that is cradled within the holder 12. Once a call is received by the smartphone, the user may, in some examples, be notified of the incoming call (e.g. via a speaker integrated to the holder 12, a visual indicator of the holder 12 producing a flashing light, a signal sent via the wireless connection between the smartphone and the holder when the incoming call is received at the smartphone), and the user may select the button to accept the call, the selection of the button sending a signal to the smartphone via the Bluetooth connection to commence the call. The incoming call may also be logged as an event in the memory 113 of the holder 12. The accepting (or declining) of the incoming call may also be logged as an event in memory 113 of the holder 12 (e.g. the event associating the log information with temporal information).

In some embodiments, a user may provide input to accept and/or decline a call through other forms of input than a press of a button, such as by producing a voice command to accept or decline (where the holder may have a speaker and a voice processor), by a touch or sequences of touches (e.g. where the holder has a touchscreen), a specific movement or hand gesture (e.g. the holder having a motion detector), etc.

In some embodiments, the holder 12 may have a speaker configured to output audio corresponding to an incoming audio signal received from said smartphone via said wireless connection once an incoming call has been accepted.

In some embodiments, the holder 12 may have a microphone configured to receive sound (e.g. dialogue) of user during a call, an outgoing audio signal corresponding to the sound sent via the wireless connection to the smartphone.

In some embodiments, the holder may provide at its screen or surface 72 an opening allowing the user to provide the necessary input on the smartphone to accept and/or decline an incoming call. The opening may be positioned over the portion of the screen of the smartphone where the user would provide the input to accept and/or decline a call.

What is claimed is:

1. A holder for securing a phone, smartphone or tablet device while driving in a vehicle, the holder comprising:
a frame for supporting said device comprising:
a base or socket shaped to receive at least a portion of said device; and
a clamping mechanism configured to secure said device in said socket;
a locking mechanism connected to said clamping mechanism, said locking mechanism comprising a motor actuating a driving member to engage and disengage a driven member of said clamping mechanism to cause said clamping mechanism to lock while tightening its grip on said device and to unlock while loosening its grip on said device.

2. The holder as defined in claim 1, wherein said clamping mechanism travels along an axis perpendicular to said base to tighten its grip on said device or to loosen its grip on said device.

3. The holder as defined in claim 1, wherein said locking mechanism comprises a rack and pinion.

4. The holder as defined in claim 1, wherein said holder comprises a connector adapted to connect to a port of said vehicle and to receive power from said vehicle via said connection.

5. The holder as defined in claim 4, wherein said connector is adapted to connect to a USB port of said vehicle.

6. The holder as defined in claim 1, wherein said clamping mechanism further comprises a spring to assist with the positioning of said clamping mechanism when transitioning between locking and unlocking its grip on said device.

7. The holder as defined in claim 1, wherein said clamping mechanism is connected to a control circuit receiving a locking signal from a user as a function of input received at a user input interface, said user input interface configured to receive press input from a user.

8. A holder for securing a phone, smartphone or tablet device while driving in a vehicle, the holder comprising:
a frame for supporting said device comprising:
a base or socket shaped to receive at least a portion of said device; and
a clamping mechanism configured to secure said device in said socket;
a wireless interface adapted to allow said holder to establish wireless communication with a remote server, and at least one of transmitting data to and receiving data from said remote server;
a clock;
a GPS receiver adapted to receive geolocation data and time data;
computer-readable memory; and
a controller configured to access said memory and to receive log information regarding an event from at least one of:
a sensor adapted to detect the presence of a device in said base or socket;
said vehicle regarding a state of said vehicle; and
said GPS receiver regarding a state of said vehicle;
wherein said controller is further configured to associate said log information with temporal information corresponding to the time of the event in accordance with said time data and position information in accordance with said geolocation data.

9. The holder as defined in claim 8, wherein said time of said clock is set as a function of said time data received via said GPS receiver.

10. The holder as defined in claim 8, wherein said position information comprises speed information of said vehicle.

11. The holder as defined in claim 8, wherein said position information comprises the geolocation of said vehicle.

12. The holder as defined in claim 8, wherein said controller is configured to receive log information regarding an event from said vehicle regarding a state of said vehicle transmitted via said wireless interface.

13. The holder as defined in claim 12, wherein said state comprises at least one:
said vehicle is turned on; and
said vehicle is turned off.

14. The holder as defined in claim 8, wherein said controller is configured to receive log information regarding an event from said GPS receiver regarding a state of said vehicle.

15. The holder as defined in claim 14, wherein said state comprises at least one of:
said vehicle travelling at a speed above a given threshold; and
said vehicle travelling at a speed below a given threshold,
wherein said speed of said vehicle is determined as a function of said geolocation data.

16. The holder as defined in claim 8, further comprising a locking mechanism configured to lock said clamping mechanism when said vehicle is in a first state and to unlock said clamping mechanism when said vehicle is in a second state.

17. The holder as defined in claim 8, wherein said wireless interface is adapted to establish a connection with a wireless modem of said vehicle and to establish said wireless communication with said remote server via said wireless modem of said vehicle.

18. The holder as defined in claim 8, further comprising a connector to connect to a port of said vehicle and to receive power via said connection.

19. The holder as defined in claim 8, wherein said controller is further configured to transmit to said remote server via said wireless interface said log information with said temporal information and said position information.

20. A holder for securing a phone, smartphone or tablet device while driving in a vehicle, the holder comprising:
a frame for supporting said device comprising:
a base or socket shaped to receive at least a portion of said device; and
a clamping mechanism configured to secure said device in said socket;
a locking mechanism configured to lock said clamping mechanism when said vehicle is in a first state and to unlock said clamping mechanism when said vehicle is in a second state;
a wireless interface configured to establish a short-range wireless connection with said smartphone;
a user input interface configured to receive input from a user; and
a controller configured to, following the reception of input from said user on said user input interface, generate and transmit a signal via said wireless interface to cause said smartphone to accept an incoming call when said smartphone is receiving said incoming call.
